(19) United States
(12) Patent Application Publication
(10) Pub. No.: US 2024/0373868 A1
(43) Pub. Date: Nov. 14, 2024

(54) TREATMENT OF GRAINS OR SEEDS FOR THE CONTROL OF MICROORGANISMS UTILIZING PEROXY ACIDS

(71) Applicant: Evonik Operations GmbH, Essen (DE)

(72) Inventors: Philip A. Block, Garnet Valley, PA (US); ELENA Pisanova, Amherst, NY (US); Aaron MacLeod, Winnipeg (CA)

(73) Assignee: Evonik Operations GmbH, Essen (DE)

(21) Appl. No.: 18/559,719

(22) PCT Filed: Apr. 29, 2022
(86) PCT No.: PCT/EP2022/061439

§ 371 Date: Nov. 8, 2023

Related U.S. Application Data
(60) Provisional application No. 63/186,642, filed on May 10, 2021.

(51) Int. Cl. A23B 9/26; A23B 9/30; A23L 3/3517; A23L 3/358; C12C 1/02; C12C 1/027

(52) U.S. Cl. CPC A23B 9/26; A23B 9/30; A23L 3/3517; A23L 3/358; C12C 1/02; C12C 1/027

(57) ABSTRACT

Compositions and methods can be used to reduce the population of microorganisms present during the processing of grain and seeds. More specifically, microorganism levels are reduced in grain and seeds being malted by contacting the grain or seeds with a sanitizing solution that contains a peroxyacid and hydrogen peroxide. This is done shortly before steeping, the first step in malting procedures. Optionally, a sanitizing solution containing a peroxyacid and hydrogen peroxide may also be used at other points in the malting process.

### FIELD OF THE INVENTION

The present invention concerns the use of antimicrobial agents in the processing of grains for use in food products and beverages.

### BACKGROUND OF THE INVENTION

Agricultural grains carry a complex microbial population that may be harmful to the quality of the products produced and, in some cases, to consumers of those products. Thus, a major objective in the processing of grains for use in foods and beverages is to reduce the levels of harmful bacteria, yeast, and filamentous fungi without compromising the quality of the products produced or the efficiency of production.

One process that is particularly common for the processing of grains used in breweries and distilleries is malting, which will often include a prewash step (also referred to herein as a “pre-steep rinse” or “pre-rinse,” and then the sequential steps of steeping, germinating and kilning. In a typical process, seeds are steeped by immersing them in a large volume of water and incubating them for 1 to 3 days. By the time that steeping is completed, the moisture content of the grain will typically have increased from about 8-13% to about 35-55%. After steeping, the grain is transferred to germination bins where it is maintained at a temperature of about 5-35° C. and at a high humidity for a period of 2-7 days. During this time, the enzymes in the seeds become activated and rootlets begin to sprout. Finally, the germinated seeds are transferred to a kiln and dried using warm air to reduce the moisture content of the grain to about 3-8%. Typically, kilning may last for 12-48 hours, although longer periods may sometimes be used.

Barley, the most commonly malted grain, typically harbors a number of harmful microorganisms, including toxigenic filamentous fungi such as species of Alternaria, Aspergillus, Fusarium, and Penicillium. The temperature and moisture conditions present during the steeping and germination phases of malting creates an environment favorable for the activation of spores of these fungi and promotes the production of mycotoxins.

Chemical disinfection methods for barley and other grains are generally avoided in commercial malting due to concerns with detrimental effects on germination, malt quality or the imparting of taints to the malt. To be suitable, a disinfectant must be economical and effective at reducing the damaging effects of microorganisms without itself having a detrimental impact on germination and malt quality. The identification of effective disinfectants and conditions for their use is therefore of great interest in the production of grain-based foods and beverages.

### SUMMARY OF THE INVENTION

### 1. General Summary

The present invention concerns a method of treating harvested grain and seeds to reduce the presence of harmful microorganisms during a malting procedure according claim 1.

The present invention is based on a recognition that the addition of a sanitizing solution, i.e., a solution comprising a peroxyacid and hydrogen peroxide, to steep water during the malting of grain or seeds is effective at reducing both the infection rate and vitality of microorganisms such as those of the genus Fusarium. However, depending on factors such as peroxyacid concentration and contact time, steeping grain or seeds at a relatively low pH (where the solution is most effective) tends to substantially reduce their subsequent ability to germinate. Prewashing grain or seeds at lower pH values, may also adversely affect germination but to a much lesser degree. Thus, by carefully controlling prewash conditions, it is possible to effectively reduce contamination and still maintain an acceptable germination level.

Raising the pH during prewash and especially during steeping substantially mitigates the detrimental effect of sanitizing solution on seed germination. Although this somewhat reduces the antimicrobial action of the PAA solution, effective decontamination is obtainable.

### II. Embodiments

The invention is particularly concerned with the use of PAA (peroxyacetic acid, also known as peroxyacetic acid) solutions for decontaminating grain and seeds in the prewash and/or steeping steps of malting. The characteristics of the procedures are described below.

### Decontamination During Prewash Processing of Grain or Seeds

In a first aspect, the invention is directed to a method of treating harvested grain or seeds to reduce the presence of harmful microorganisms during malting, a process that includes one or more sequential steps of steeping, germinating and kilning and that may also include a prewash step prior to steeping. During prewash, a decontamination can be performed by contacting the grain or seeds with a sanitizing solution. The sanitizing solution should typically have 250-5000 ppm peroxyacid however alternative concentrations of peroxyacid may also be used. In one embodiment, the prewash is accomplished by exposing the grain or seeds to sanitizing solution without adjusting the pH. Thus, the pH should be below 8.0 and generally in the range of 5.0 to 8.0. In an alternative embodiment, the pH is adjusted (e.g., by adding a pH modifier include but not limited to metal hydroxides, such as NaOH, KOH, phosphates, carbonates, bicarbonates, and metal oxides) to 8.0 or above (preferably to a pH of 9.0 or above with ranges being 8.0 to 12 and preferably 9.0 to 12 or 9.0 to 11).

Contact between the grain or seeds and the sanitizing solution is maintained for a period sufficient to reduce Fusarium (as evidenced, for example by a reduction in deoxynivalenol (DON) toxin), the total microbial count (APC) of the grain or seeds, and/or the yeast and mold count (YM) by at least 40% (and preferably 60% or 80%) compared to the same grains or seeds prior to contact with sanitizing solution. In general, in pre-wash stage contact should be maintained for at least 5 minutes, for example 5 minutes to 60 minutes. During steep stage contact should be maintained for at least 1 hour, for example 1 hour to 6 hours from the end of the steep stage. However, longer incubation times and/or higher concentrations of peroxyacid and hydrogen peroxide may be used to increase the percentage of microorganisms killed. The temperature during the prewash will typically be 10 to 20° C. and more typically 12 to 17° C. but temperatures outside of these ranges may also be used. Microorganisms that may be killed include molds, yeast, bacteria or fungi, particularly Fusarium, Alternaria, Mucor, Penicillium, or Aspergillus.

A convenient way to express microbial reduction performance that takes into account both the concentration of PAA and the duration of contact is in terms of integrated concentration×time or “ICT” (mg PAA×min/liter). Using this parameter, prewash in the absence of pH adjustment as described above should generally be performed for 20000-120000 ICT, and preferably from 20000-100000 ICT, 40000-80000 ICT or 40000-60000 ICT. If the pH is adjusted to 8.0 or above (for example in a range of 8.0 to 12, or 9.0 to 11.0), the prewash can be performed for greater than 100000 ICT without an unacceptable decrease in germination. Thus, the prewash may be performed for at least 20000 ICT, 40000 ICT or 80000 ICT or, in terms of a range, 10000-120000 ICT, 20000-100000 ICT, 40000-100000 ICT, or 40000-120000 ICT.

### Decontamination During the Steeping of Grain or Seeds

If a prewash step is used during malting, steeping should generally begin within 24 hours after it has been completed and if the prewash involved a decontamination as described above, prior to steeping, the grain or seeds may optionally be washed to remove the sanitizing solution and/or the sanitizing solution may be treated with a reducing agent to neutralize PAA. Steeping will generally involve adding 2-5 volumes of water to grain or seeds and incubating the resulting mixture for a period of time sufficient to raise the moisture content of the grain or seeds to 35-55%. Typically, this will require 1-4 (or 1-3) days at a temperature of about 5-35° C. The process will usually include at least one cycle in which fluid is drained from the mixture, the grain or seeds are exposed to air and then resubmerged.

Sanitizing solution containing PAA as discussed above may be included during all or part of steeping and, if this is done, an elevated pH should be used to prevent a negative effect on germination. Steeping should be carried out at a pH of 8-12 and more preferably 9-12 or 9-11. The concentration of peroxyacid may be 250-5000 ppm (or alternatively 250-1000 ppm; 250-750 ppm) and the time of contact can be for a portion of the steeping step or for the entire step (for example it might last for up to 72 hours; up to 48 hours; up to 24 hours, for 1-24 hours, for 1-10 hours or for less than 1 hour).

Contact between the grain or seeds and the sanitizing solution should be maintained for a period sufficient to reduce Fusarium levels (for example, as measured by DON levels), total microbial count (APC) or the yeast and mold count (YM)) by at least 20% (preferably at least 40%; 60% or 80%) compared to the same grains or seeds prior to contact with sanitizing solution. The temperature during the prewash typically be 10 to 20° C. and more typically 12 to 17° C. However, temperatures outside of these ranges may also be used.

Contact between sanitizing solution and grain or seeds during steeping can be effectively expressed in terms of ICT. Using this parameter, a significant reduction in microbial contamination without a substantial reduction in germination may be obtained with an ICT of at least 5500 and preferably at an ICT of at least 20000, 40000, 80000 or 100000. In terms of a range, contact may be for 5500 to 120000 ICT, 20000-120000 ICT, 20000-100000 ICT, 40000-100000 ICT or 80000-100000 ICT.

### Combined Decontamination During Prewash and Steeping Procedures

A malting procedure within the scope of the invention may include either a prewash with a decontamination as described above, a steeping procedure with a decontamination as described above, or both a prewash and steeping decontamination. Decontamination using PAA may also be carried out at other steps in a malting process and in conjunction with other decontamination agents or procedures.

To avoid adverse effects on germination, steeping should be carried out at an elevated pH (8-12). Prewashing may be carried out in the absence of pH adjustment (pH between 5 and 8) but in order to maintain good germination, the ICT should not extend beyond about 80000 and preferably not beyond about 60000. If the pH is raised to 8-12, the ICT can be at least 100000 without causing an unacceptable effect on germination. An effective range would be, for example, 20000 to 80000 ICT, 40000 to 80000 ICT or 40000 to 60000 ICT.

### Types of Grains or Seeds and Peroxacids

Grain or seeds that may be used in the decontamination procedures described herein include without limitation barley, wheat, rye, millet, corn (maize), rice, and oats. The most preferred is barley seeds.

Sanitizing solution may be applied to seeds or grains in any way known in the art, with washing or spraying the grain or seeds being a preferred method.

Although compositions and procedures are described primarily with respect to peracetic acid (PAA) and this is the most preferred peracid for use in sanitizing solutions, other peracids may also be used to replace or supplemental peracetic acid in any of the procedures or compositions described herein. These include: percitric acid, perlactic acid, perpropionic acid, peroxalic acid, permalic acid, permalonic acid, persuccinic acid, perglutaric acid, peradipic acid, permaleic acid, perfumaric acid and mixtures thereof.

### BRIEF DESCRIPTION OF THE DRAWINGS

FIG. 1: FIG. 1 shows Germination Index for PAA Added During Steeping with and without pH adjustment

FIG. 2: FIG. 2 shows DON Concentration with PAA Added During Steep Stage with and without pH Adjustment

FIG. 3: FIG. 3 shows Germination Index with PAA Added During Pre-Wash with and without pH Adjustment

FIG. 4: FIG. 4 shows DON Concentration with PAA Added to the Pre-Wash with and without pH adjustment

### DEFINITIONS

Sanitizing solution: As used herein, this term refers to a composition comprising a peroxyacid and hydrogen peroxide which can be used to reduce the number of microorganisms in a harvested grain or seed.

Malting: This refers to a process in which harvested grains and seeds are steeped, germinated and kilned. A prewash may also be present. Malted grains and seeds are primarily used in making beer, ale and hard liquors.

Steeping: Steeping involves immersing grain or seeds in a large volume of water to form a steep mixture. The mixture is incubated, typically with one or more periods during which the water is removed, grains or seed are exposed to air and then re-immersed. The objective is to promote the absorption of water by the seeds or grains and to thereby activate enzymes that promote germination. Typically, steeping is performed in a large container, such as a vessel or vat, which may be equipped with mechanical stirring, agitation and/or aeration equipment. A wide variety of steeping protocols may be employed depending on the type of harvested grain to be malted, the harvested grain quality and kernel size, the steeping vessel configuration, the downstream application of the malted grain, and maltster preferences. Harvested grain may be steeped more than once and two or three steepings are common, often over a total period of 2-4 days. Where multiple steepings are performed, the grain may be rested or aerated between steepings.

Germinating: After the harvested grain is steeped in water, it is sprayed with water during germination. The germinating step may be performed at a temperature of about 5° C.-35° C. for a period of about 3 to 7 days. In some cases, germination also includes one or more transfers of the grain or seeds from one germination box to another, spraying one or more times with water, separating the germinated grain from the aqueous solution, and optionally washing the germinated grain with water after the separating step. For example, the cereal grain may be filtered from the aqueous solution after the solution spraying step(s) and optionally washed with water.

Kilning: This is the final step in malting and involves heating the germinated grain to dry it and stop germination. Typically, this is done using dry convection heat and results in grain or seeds with a water content of about 5%. Kilning typically takes about 12-24 hours but much longer times may be used in some instances.

Peroxyacid: As used herein, a peroxyacid (or peracid) is a peroxy derivative of an organic carboxylic acid and is characterized by the presence of an acidic-OOH group.

### DETAILED DESCRIPTION OF THE INVENTION

In the present invention, sanitizing solutions containing peroxyacids and hydrogen peroxide are added during the pre-wash and/or during the steeping stage. This may be done by spraying the solution onto the grain or seeds or by briefly immersing the grains or seeds until a desired reduction in the number of microorganisms is reached. For example, the total number of microorganisms reduction may be 20% to 80%. Steeping may be performed without pH adjustment or after the pH is raised to above 8.

Steeping can then be performed at a high pH for a period of as long as 1-3 days or for any portion of the steeping process, e.g., 1-8 hours). When sanitizing solution is present during steeping, it is preferable to keep the pH high (8-12, 8-11 or more preferably, 8-10) to mitigate adverse effects on germination. Sanitizing solution may also be used after steeping and before germination, during germination, after germination and before kilning, or after kilning.

The preferred peroxyacid is Peroxyacetic Acid (PAA). The period of time that contact is maintained can vary. For example, depending on concentration, PAA can be maintained during steeping or germination for half an hour to several hours. Alternatively, high concentrations of peroxyacid (e.g., 250-100 ppm or 250-750 ppm) can be incubated for a shorter period at a pH of 8-12. In all instances, the objective is to eliminate as many potentially harmful microorganisms as possible while avoiding or minimizing unwanted effects on the efficiency of germination.

### Embodiments

The present invention relates to a method of treating harvested grain or seeds to reduce the presence of harmful microorganisms during a malting procedure, comprising performing a decontamination by contacting the grain or seeds with a sanitizing solution comprising a peroxyacid and hydrogen peroxide, wherein:
a) said malting procedure comprises sequentially performing at least one steeping step and at least one germination step;
b) during the steeping step, the grain or seeds are contacted with sanitizing solution comprising peroxyacid at a pH of 8-12, especially 9-11;
c) contact between the grain or seeds and the sanitizing solution is maintained for a period sufficient to reduce DON (deoxynivalenol) toxin to equal or to less than 0.6 mg/kg.

The steeping step is part of the malting procedure. Preferably contact between the grain or seeds and the sanitizing solution is maintained for a period sufficient to reduce the total microbial count (APC) or the yeast and mold count (YM) by at least 40%, more preferred at least 60%, most preferred at least 80% compared to the same grain or seeds prior to contact with sanitizing solution. Preferably contact between the grain or seeds and the sanitizing solution is performed at an integrated concentration×time, expressed as mg peracid×min/L (ICT) of 20000-120000, more preferred at 40000-100000 ICT. Preferably the grain or seeds are barley, wheat, rye, millet, corn (maize), rice, or oats. More preferred the grain or seeds are barley seeds. Preferably the peroxyacid used in decontaminating grain or seeds is selected from the group consisting of: peracetic acid, percitric acid, perlactic acid, perpropionic acid, peroxalic acid, permalic acid, permalonic acid, persuccinic acid, perglutaric acid, peradipic acid, permaleic acid, perfumaric, performic acid and mixtures thereof. More preferred peroxyacid is peracetic acid.

The invention further relates in a second embodiment to a method of treating harvested grain or seeds to reduce the presence of harmful microorganisms during a malting procedure, comprising performing a decontamination by contacting the grain or seeds with a sanitizing solution comprising a peroxyacid and hydrogen peroxide, wherein:
a) said malting procedure comprises sequentially performing at least one prewash step, at least one steeping step and at least one germination step, or any combination thereof;
b) during the prewash step, the grain or seeds are contacted with sanitizing solution comprising peroxyacid at a pH of 5-8;
c) contact between the grain or seeds and the sanitizing solution is maintained for a period sufficient to reduce DON (deoxynivalenol) toxin to equal to or to less than 0.6 mg/kg,

The pH of 5-8 conforms typically an unadjusted pH of the sanitizing solution.

In this embodiment the contact between the grain or seeds and the sanitizing solution is preferably maintained for a period sufficient to reduce the APC or the yeast and mold count (YM) by at least 40%, more preferred at least 60%, most preferred at least 80%, compared to the same grain or seeds to contact with sanitizing solution.

Further on, in the second embodiment the contact between the grain or seeds and the sanitizing solution is preferably performed at an integrated concentration*time, expressed as mg peracid*min/L (ICT) of 10000-80000, more preferred at 10000-60000 ICT, most preferred at 20000-60000 ICT. Preferably the grain or seeds are preferably barley, wheat, rye, millet, corn (maize), rice, or oats, wherein barley is most preferred. Preferably the peroxyacid used in decontaminating grain or seeds is selected from the group consisting of: peracetic acid, percitric acid, perlactic acid, perpropionic acid, peroxalic acid, permalic acid, permalonic acid, persuccinic acid, perglutaric acid, peradipic acid, permaleic acid, perfumaric acid and mixtures thereof. More preferred wherein the peroxyacid is peracetic acid.

Preferably the grain or seeds are not contacted with sanitizing solution during the steeping step in the second embodiment.

Alternative in the second embodiment, during the steeping step, the grain or seeds are contacted with sanitizing solution comprising peroxyacid at a pH of 8-12, more preferred at a pH of 9-11. Wherein preferably contact between the grain or seeds and the sanitizing solution during steeping is maintained for a period sufficient to reduce DON (deoxynivalenol) toxin to equal to or to less than 0.6 mg/kg. Preferably contact between the grain or seeds and the sanitizing solution during steeping is maintained for a period sufficient to reduce the APC or the yeast and mold count (YM) by at least 40% compared to the same grain or seeds prior to contact with sanitizing solution. Preferably, the contact between the grain or seeds and the sanitizing solution during steeping is maintained for a period sufficient to reduce the APC or the yeast and mold count (YM) by at least 60% compared to the same grain or seeds prior to contact with sanitizing solution. Preferably, contact between the grain or seeds and the sanitizing during steeping is performed at an ICT of 20000-120000. More preferred contact between the grain or seeds and the sanitizing solution during steeping is performed at 40000-100000 ICT. Preferably the grain or seeds are barley, wheat, rye, millet, corn (maize), rice, or oats, more preferred the grain or seeds are barley seeds. Preferably, the peroxyacid used in decontaminating grain or seeds is selected from the group consisting of: peracetic acid, percitric acid, perlactic acid, perpropionic acid, peroxalic acid, permalic acid, permalonic acid, persuccinic acid, perglutaric acid, peradipic acid, permaleic acid, perfumaric acid and mixtures thereof, even more preferred the peroxyacid is peracetic acid.

In a third embodiment the invention further relates to a method of treating harvested grain or seeds to reduce the presence of harmful microorganisms during a malting procedure, comprising performing a decontamination by contacting the grain or seeds with a sanitizing solution comprising a peroxyacid and hydrogen peroxide, wherein:
a) said malting procedure comprises sequentially performing at least one prewash step, at least one steeping step and at least one germination step or a combination thereof;
b) during the prewash step, the grain or seeds are contacted with sanitizing solution comprising peroxyacid at a pH of 8-12;
c) contact between the grain or seeds and the sanitizing solution is maintained for a period sufficient to reduce DON (deoxynivalenol) toxin to equal or to less than 0.6 mg/kg.

The pH of sanitizing solution is adjusted, preferably with sodium hydroxide or another pH modifier, to achieve a pH of 8-12, more preferred 9-10. With adjustment of the pH only little or no impact on germination will be achieved in contrast to a sanitizing solution with an acidic pH.

Preferably, contact between the grain or seeds and the sanitizing solution is maintained for a period sufficient to the APC or the yeast and mold count (YM) by at least 60%, more preferred at least 80% compared to the same grain or seeds prior to contact with sanitizing solution. Preferably contact between the grain or seeds and the sanitizing solution is performed at an ICT of 5000-120000, more preferred at 10000-100000 ICT, most preferred at 20000-100000 ICT. Wherein preferably the grain or seeds are barley, wheat, rye, millet, corn (maize), rice or oats, more preferred the grain or seeds are barley seeds. Preferably the peroxyacid used in decontaminating grain or seeds is selected from the group consisting of: peracetic acid, percitric acid, perlactic acid, perpropionic acid, peroxalic acid, permalic acid, permalonic acid, persuccinic acid, perglutaric acid, peradipic acid, permaleic acid, perfumaric acid and mixtures thereof, even more preferred the peroxyacid is peracetic acid.

Optional the grain or seeds are not contacted with sanitizing solution during the steeping step.

Alternative in the third embodiment contact between the grain or seeds and the sanitizing solution is performed during steeping and is maintained for a period sufficient to reduce DON (deoxynivalenol) toxin to equal or to less than 0.6 mg/kg. Preferably contact between the grain or seeds and the sanitizing solution during steeping is maintained for a period sufficient to reduce the APC or the yeast and mold count (YM) by at least 20%, more preferred at least 40%, most preferred at least 60% compared to the same grain or seeds prior to contact with sanitizing solution. Preferably, contact between the grain or seeds and the sanitizing during steeping is performed at an ICT of 20000-120000, more preferred at 40000-100000 ICT. Preferably, the grain or seeds are barley, wheat, rye, millet, corn (maize), rice or oats, more preferred the grain or seeds are barley seeds. Preferably during steeping, the pH of the sanitizing solution is 9-11. Preferably, the peroxyacid used in decontaminating grain or seeds is selected from the group consisting of: peracetic acid, percitric acid, perlactic acid, perpropionic acid, peroxalic acid, permalic acid, permalonic acid, persuccinic acid, perglutaric acid, peradipic acid, permaleic acid, perfumaric acid and mixtures thereof, more preferred the peroxyacid is peracetic acid.

### EXAMPLES

The following examples are intended to illustrate, but not limit the invention.

### I. Example I: Addition of Peracetic Acid During the Steeping Process to Control Fusarium and DON Concentrations

The objective of this study was to determine the effectiveness of PAA as an anti-microbial treatment employed during the barley steeping process to reduce the presence of Fusarium and the associated concentration of the mycotoxin DON while assessing the impact of the treatment process on germination.

The barley used for these experiments was of the two-rowed winter variety LCS Violetta from the 2019 harvest grown in North Carolina. The grain was naturally infected with Fusarium Head Blight and had an average DON concentration of 1.5 mg/kg. Other than the DON concentration, the grain met all of the standard criteria for suitability for malting.

PAA solutions were prepared by dilution of a peracetic acid solution containing 15 wt % PAA and 10 wt % hydrogen peroxide (VIGOROX 15/10) with the appropriate amount of reverse osmosis purified water to achieve the desired in-use concentrations of 50, 100, 250, 500, 750, 1000, 1500 and 2000 mg PAA/L solution. The concentration of PAA within the solutions was determined by a colorimetric analysis using a commercial kit (Chemetrics VACUettes) per the standard Method SM 4500-PAA. PAA concentrations in the steep water with grain present was measured initially and after 30 min, 1 hour, and hourly thereafter for 8 hours. Controls were run where no PAA was added to the steep water.

Malts were prepared using an automated micromalting system manufactured by Custom Lab Products. Samples were steeped with an initial immersion period of 8 hours at 15° C. This was followed by an air rest period of 16 hours and subsequent immersion of 8 hours to 45% moisture content. Steeped barley was germinated for 96 h at 15° C. and 100% relative humidity. Kilning was carried out over 24 hours by influx of dry air using temperature levels as follows: 12 hours at 55° C.; 6 hours at 65° C.; 2 hours at 75° C.; 4 hours at 85° C.

Peracetic acid was added to the first steep stage at 1, 2, 4 and 8 hours from the end of the stage to the target concentrations. When needed, the pH of the steeping solutions was modified to a pH of 9.0 with appropriate quantities of 30 wt % sodium hydroxide.

Germination ability was assessed by counting the number of chitted (sprouted) kernels after 24, 48, and 72 hours (n24, n48, and n72 respectively). The Germination Energy (GE) is reported as the total number of kernels which germinate after 72 hours and is generally interpreted as an indication of the germinative vitality. The Germination Index (GI), generally interpreted as an indication of the germinative vigor was calculated using the formula:

$$GI = 10 \times ( n 24 + n 48 + n 72 ) \div ( n 24 + 2 n 48 + 3 n 72 ) .$$

Yeast and Mold Count were determined by diluting 10 g of finished malt in 90 mL of sterile 0.1% peptone water and homogenized by shaking for 10 minutes at 250 rpm. Serial dilutions of the supernate extract were prepared for plating. Yeasts and Moulds were enumerated on Oxytetracycline Glucose Agar (OGA) with blue producing phosphate enzyme substrate after incubation in the dark at 25° C. for 5 days. The results obtained for yeast and mold were expressed as log 10 colony forming units/gram of barley (log 10 CFU/g).

DON was assessed by grinding 50 g of finished malt with a burr mill to pass a 1.5 mm screen and extracted with 250 ml of purified RO water by shaking for 1 minute. After settling for 2 minutes, 100 μL of supernate was diluted in 1.0 mL of buffer and assayed for DON by Lateral Flow Immunoassay (CHARM ROSA DON Q2).

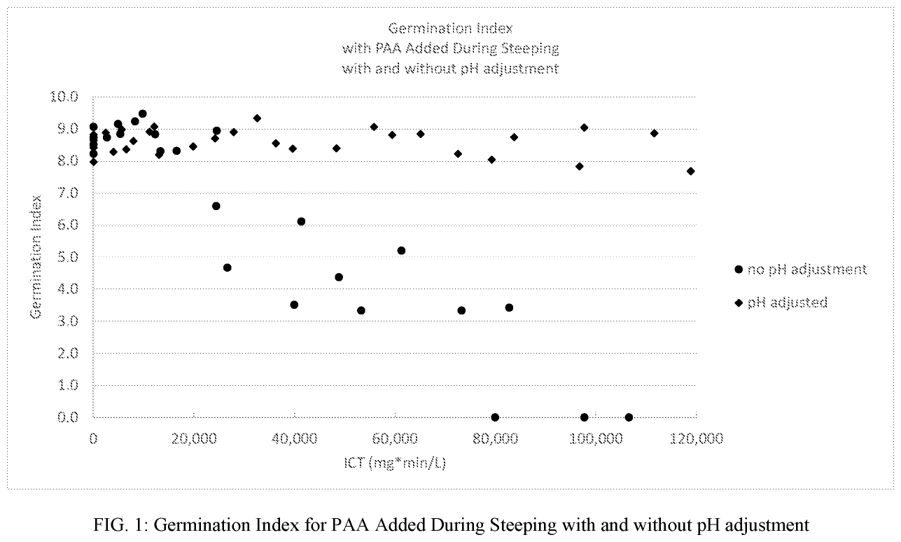

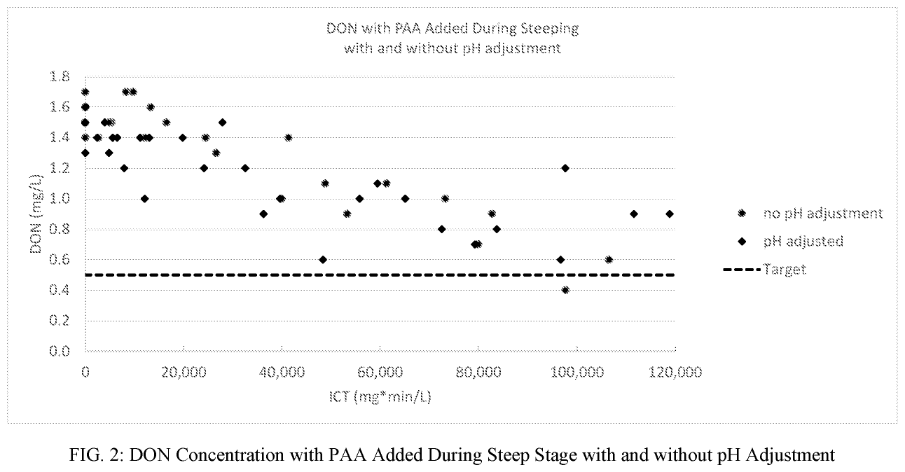

The Germination Index results for this experiment are shown in FIG. 1. FIG. 2 shows the reduction in DON after addition of PAA in the steep stage, with and without pH modification to 9. It can be observed that with PAA added during the steeping stage, adequate reductions in DON can be achieved with ICT's in excess of 100,000 mg*min/L, and when the pH is adjusted to 9, no impact on germination index is measured. In comparison the control (ICT=0), shows a DON concentration of around 1.5 mg/kg.

### II. Example II: Addition of Peracetic Acid During a Pre-Wash Step to Control Fusarium and DON Concentrations

This experiment was run under the same conditions and process as Example 1, but with the peracetic acid being added to a pre-wash step prior to the first steep stage. For this example, the pre-wash lasted one hour, during which the peracetic acid, and pH modifier if required, was added at the beginning of the pre-wash stage. At the end of the pre-wash stage, the water was drained, and the micro-malting proceeded as in Example 1, but without PAA or pH modifier being added during the steeping stage.

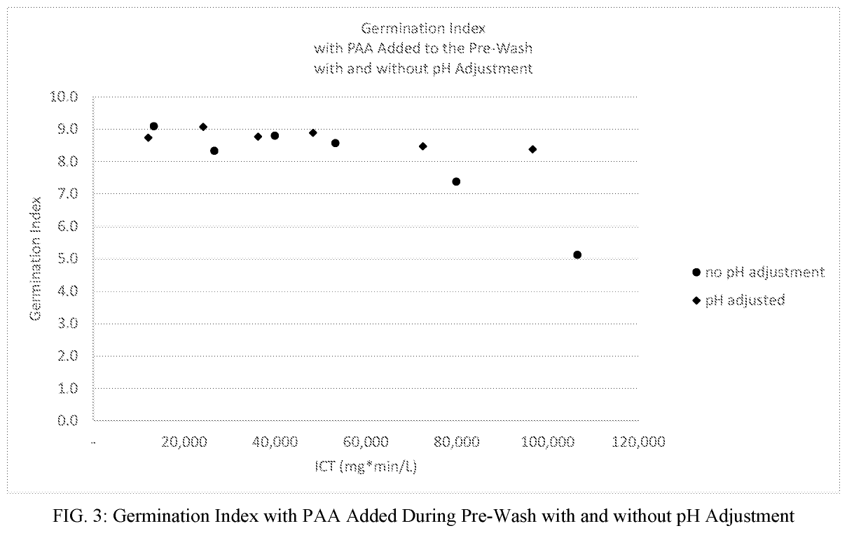

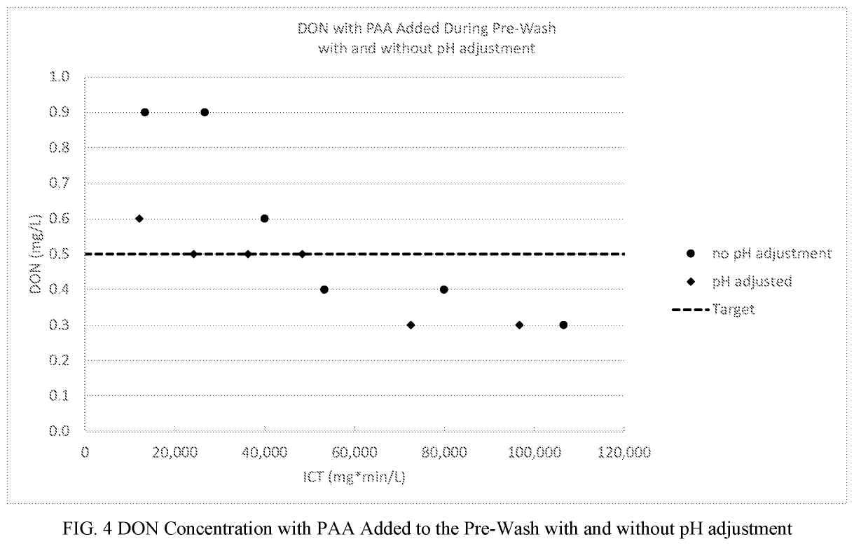

The impact of PAA addition in the pre-wash stage, with and without pH modification, on the barley germination index can be seen in FIG. 3. Reduction in DON concentrations are shown in FIG. 4. When PAA is added to the Pre-Wash stage, DON can be reduced to below 0.5 mg/kg with no significant reduction in germination index with ICT's of 20,000 mg*min/L to an excess of 100,000 mg*min/L, whereas the control with no PAA present (ICT=0) had a DON concentration of 1.5 mg/kg. These results show that the addition of PAA in a pre-wash step can adequately control DON without impacting the barley germination process, with improved results when the pH is adjusted to 9.0.

### III. Example III: The Impact of PAA Addition During a Pre-Wash Step on the Final Beer Produced in a Pilot Malting/Brewing Process

The impact of PAA added during a pre-wash stage with pH modification on the DON concentration and quality of a beer produced in a pilot micro-malting/brewing system was determined.

Malts were prepared using an automated micromalting system manufactured by Custom Lab Products. The subsequent produced malts were then brewed to form beer and final malt and beer quality parameters were measured per industry standard. The micro-malting and brewing steps consisted of:
1) A pre-wash stage in which 1 kg of barley was added to 2.5 L of water containing 1740 mg PAA/L, with pH adjusted to 9.0 with NaOH. The pre-wash stage lasted for one hour
2) After one hour, the water was drained and the first steep stage commenced in which the 1 kg barley was added to 2.5 L water and allowed to steep for 7.5 hours.
3) After 7.5 hours the water was drained, and a second steep period commenced with the 1 kg of barley added to 2.5 L water and allowed to steep for another 7.5 hours.
4) After 7.5 hours, the water was drained and the barley was placed in a germination bed. The seeds were allowed to germinate for four days at 15° C.
5) After 4 days, the germinated seeds were dried for 24 hours. The 24-hour drying process consisted of six hours at 55 C, followed by six hours at 65 C, followed by six hours at 72 C, followed by a final six hours at 85° C.
6) The malted barley was then taken to a mashing process in which 1 kg of malt was added to 4 to 8 kg of water.
7) Following mashing, solubilized malt was decanted and sugar was added to 8% to form the sweet wort
8) Yeast was then added to the sweet wort and the solution was allowed to ferment, yielding the final beer product.

A control sample was also produced through this process, but with no PAA added during the pre-wash stage. Analysis of the malt and beer for the PAA treated barley and the control sample are shown in Table 1. From the results, it can be seen that the addition of PAA and a pH modifier to a pre-wash stage did not negatively impact any of the barley and beer quality parameters. However, the DON concentration was reduced from 1.2 in the control beer sample to 0.4 in the beer sample produced from the barley treated with PAA.

TABLE 1
Malt and Beer Quality with and without the Addition
of PAA and pH modifier During a Pre-wash Stage

| | | 1 h PAA Rinse |
|---|---|---|
| | Control | 1500 ppm @ pH 9.0 |
| Steep Out Moisture, % | 44.6 | 45.0 |
| Chitting, % | 98 | 97 |
| Malt Moisture, % | 4.0 | 3.9 |
| Friability, % | 93.3 | 93.0 |
| Fine Extract, % D.B. | 81.8 | 81.6 |
| Color, °SRM | 2.40 | 2.29 |
| β-glucan, mg/L | 130 | 143 |
| Soluble Protein, % | 5.55 | 5.59 |
| Total Protein, % | 11.8 | 11.8 |
| S/T, % | 47.0 | 47.5 |
| FAN, mg/L | 259 | 254 |
| Diastatic Power, °L | 129 | 128 |
| α-amylase, D.U. | 71.8 | 72.2 |
| Filtration Time | normal | normal |
| Clarity | clear | clear |
| pH | 5.77 | 5.77 |
| DON, ppm | 1.2 | 0.4 |

### REFERENCES

1. U.S. Pat. No. 6,927,192. Process to improve the quality of grains and seeds.
2. US patent Application 2016/0044940 A1. Method of treating grains and treated grains.
3. Kunz, T. and Methner, F.-J. The cleaning effect on brewing barley using vibrations during wet steeping. BrewingScience 2015, Vol. 68, pp. 29-37.
4. J. W. Green and M. J. Sanger, EFFECT OF HYDROGEN PEROXIDE AND OF PERACETIC ACID IN MALTHOUSE STEEP LIQUOR. J. Inst. Brew., Vol. 62, 1956, pp. 170-179.
5. Rood, L., Koutoulis, A., et al. Control of microbes on barley grains using peroxyacetic acid and electrolyzed water as antimicrobial agents. Food Microbiology, 76 (2018) pp. 103-109.
6. U.S. Pat. No. 9,622,495. Methods to decontaminate cereal grains with Chlorine Dioxide.
7. Van Nierop, S. N., et al. The impact of microorganisms on barley and malt quality-A review. Journal of the American Society of Brewing Chemists, 2006; 62 (2); pp. 69-79.
8. Dodd, G. J., et al. Effect of Ozone Treatment on the Safety and Quality of Malting Barley. Journal of Food Protection, Vol. 74, No. 12, 2011, Pages 2134-2141.

All references cited herein are fully incorporated by reference. Having now fully described the invention, it will be understood by one of skill in the art that the invention may be performed within a wide and equivalent range of conditions, parameters and the like, without affecting the spirit or scope of the invention or any embodiment thereof.

1. A method of treating harvested grain or seeds to reduce the presence of harmful microorganisms during a malting procedure, the method comprising:
performing a decontamination by contacting the grain or seeds with a sanitizing solution comprising a peroxyacid and hydrogen peroxide, wherein:
a) the malting procedure comprises sequentially performing at least one steeping and at least one germination;
b) during the malting procedure, the grain or seeds are contacted with the sanitizing solution comprising a peroxyacid at a pH of 5-12;
c) contact between the grain or seeds and the sanitizing solution is maintained for a period sufficient to reduce DON (deoxynivalenol) toxin to equal or to less than 0.6 mg/kg.

2. The method of claim 1, wherein the grain or seeds are contacted with the sanitizing solution during the at least one steeping, wherein the sanitizing solution comprises a peroxyacid at a pH of 8-12.

3. The method of claim 1, wherein the malting procedure according a) comprises sequentially performing at least one prewash, the at least one steeping and the at least one germination, or any combination thereof; wherein during the at least one prewash the grain or seeds are contacted with the sanitizing solution comprising a peroxyacid.

4. The method of claim 3, wherein during the at least one prewash the grain or seeds are contacted with the sanitizing solution comprising a peroxyacid at a pH of 5-8.

5. The method of claim 3, wherein during the at least one prewash the grain or seeds are contacted with the sanitizing solution comprising a peroxyacid at a pH of 8-12.

6. The method of claim 3, wherein the grain or seeds are not contacted with the sanitizing solution during the at least one steeping.

7. The method of claim 3, wherein during the at least one steeping, the grain or seeds are contacted with the sanitizing solution comprising a peroxyacid.

8. The method of claim 2, wherein contact between the grain or seeds and the sanitizing solution during the at least one steeping is performed at an integrated concentration*time, expressed as mg peracid*min/L (ICT) of 20000-120000 ICT.

9. The method of claim 4, wherein contact between the grain or seeds and the sanitizing solution during the at least one prewash is performed at an integrated concentration*time, expressed as mg peracid*min/L (ICT) of 10000-80000 ICT.

10. The method of claim 5, wherein contact between the grain or seeds and the sanitizing solution during the at least one prewash is performed at an integrated concentration*time, expressed as mg peracid*min/L (ICT) of 5000-120000 ICT.

11. The method of claim 1, wherein contact between the grain or seeds and the sanitizing solution is maintained for a period sufficient to reduce a total microbial count (APC) or a yeast and mold count (YM) by at least 40% compared to the same grain or seeds prior to contact with the sanitizing solution.

12. The method of claim 1, wherein the grain or seeds are at least one selected from the group consisting of barley, wheat, rye, millet, corn (maize), rice, and oats.

13. The method of claim 1, wherein the peroxyacid is selected from the group consisting of: peracetic acid, percitric acid, perlactic acid, perpropionic acid, peroxalic acid, permalic acid, permalonic acid, persuccinic acid, perglutaric acid, peradipic acid, permaleic acid, perfumaric acid, performic acid, and mixtures thereof.

14. The method of claim 1, wherein the peroxyacid is peracetic acid.

15. The method of claim 2, wherein the sanitizing solution comprises a peroxyacid at a pH of 9-11.

16. The method of claim 7, wherein during the at least one steeping the grain or seeds are contacted with the sanitizing solution comprising a peroxyacid at a pH of 9-11.

17. The method of claim 8, wherein contact between the grain or seeds and the sanitizing solution during the at least one steeping is performed at an integrated concentration*time, expressed as mg peracid*min/L (ICT) of 40000-100000 ICT.

18. The method of claim 9, wherein contact between the grain or seeds and the sanitizing solution during the at least one prewash is performed at an integrated concentration*time, expressed as mg peracid*min/L (ICT) of 20000-60000 ICT.

19. The method of claim 10, wherein contact between the grain or seeds and the sanitizing solution during the at least one prewash is performed at an integrated concentration*time, expressed as mg peracid*min/L (ICT) of 20000-100000 ICT.

20. The method of claim 11, wherein contact between the grain or seeds and the sanitizing solution is maintained for a period sufficient to reduce the total microbial count (APC) or the yeast and mold count (YM) by at least 80% compared to the same grain or seeds prior to contact with the sanitizing solution.
